(19) United States
(12) Patent Application Publication
(10) Pub. No.: US 2017/0031110 A1
(43) Pub. Date: Feb. 2, 2017

(54) FERRULE HOLDER FOR OPTICAL FIBER PROCESSING TOOL

(71) Applicant: Corning Optical Communications LLC, Hickory, NC (US)

(72) Inventors: Venkata Adiseshaiah Bhagavatula, Big Flats, NY (US); Mark Leon Morrell, Horseheads, NY (US)

(21) Appl. No.: 15/219,397

(22) Filed: Jul. 26, 2016

Related U.S. Application Data
(60) Provisional application No. 62/198,821, filed on Jul. 30, 2015.

(51) Int. Cl. G02B 6/38; C03C 25/62

(52) U.S. Cl. CPC G02B 6/3898; G02B 6/3863; G02B 6/3886; G02B 6/3882; C03C 25/6233

(57) ABSTRACT

A ferrule holder for a tool for processing an end face of an optical fiber held by a ferrule of an optical fiber connector is disclosed. The ferrule holder includes first and second confronting faceplates, with the first face plate operably arranged with the tool. The first and second face plates are configured to magnetically engage while being kinematically aligned. The second face place is configured to receive the optical fiber connector and the ferrule therein so that the end face of the optical fiber resides immediately adjacent an aperture of the first face plate. Light from a light source in the tool is directed through the aperture to process the fiber end. The second face plate can be disengaged from the first face plate and replaced with another second face plate configured to accommodate a ferrule having a different size.

### PRIORITY APPLICATION

This application claims the benefit of priority under 35 U.S.C. §119 of U.S. Provisional Application Ser. No. 62/198,821, filed on Jul. 30, 2015, the content of which is relied upon and incorporated herein by reference in its entirety.

### FIELD

The present disclosure relates to optical fiber processing, and in particular relates to a ferrule holder for an optical fiber processing tool, such as used for laser processing of optical fiber ends.

### BACKGROUND

Optical fibers are used in a variety of optical and telecommunications applications. Optical fiber connectors are used to connect two optical fibers so that the optical communication can take place between the two connected fibers. Often the optical fiber connectors are installed in the field, with such connectors being referred to as “field-installable connectors.” As the name implies, the connectors are installed in less than ideal circumstances for precision assembly. Consequently, such connectors and assembly processes need to be simple and reliable while meeting stringent performance requirements. Also, the tools used for the connector installation need to be portable, easy to use, rugged and preferably battery operated.

The assembly of connectors involves several steps, including the end preparation of the optical fibers to be connectorized. In general, end preparation involves four main process steps: (1) stripping the polymer coating to expose a select length of the bare glass fiber; (2) precision cleaving the bare glass fiber section with controlled end angles and surface quality; (3) inserting the optical fiber in a ferrule of the connector to have a controlled protrusion distance from the ferrule; and (4) polishing the end face of the optical fiber that protrudes from the ferrule.

The first step is currently done manually using a mechanical stripper. This process can introduce flaws in the glass fiber that can reduce the optical fiber strength. Consequently, a non-mechanical coating stripping process that does not cause flaws in the glass fiber are desired. To get a controlled protrusion distance and a high-quality fiber end face, the end face of the optical fiber is polished after fixing the optical fiber in the connector ferrule. Generally, this involves several polishing steps with progressively finer polishing pads. The polishing pads need to be replaced after each connector assembly, particularly the final polishing pad. This is a time consuming process whose outcome is very much operator dependent.

One of the difficulties in the end face preparation or processing of optical fibers to be connectorized is that the ferrules that hold the optical fibers can vary in size, e.g., from 1.25 mm diameter for LC type connectors to 2.5 mm in diameter for SC type connectors. Consequently, the tool used to perform endface processing needs to readily accommodate different size ferrules while maintaining the tight lateral and longitudinal alignment tolerances for endface processing. These tolerances are about 10 microns for lateral offset and in the range from about 100 microns to 150 microns for longitudinal offsets.

### SUMMARY

An aspect of the disclosure is a ferrule holder for holding a ferrule of an optical fiber connector, wherein the ferrule holds an optical fiber having an end face to be processed by an optical fiber processing tool that uses light. The ferrule holder includes: a first face plate having a first magnetic feature, first kinematic alignment features and a conical bore with a wide proximal end and a narrow distal end that defines a narrow aperture; a second face plate having a second magnetic feature complementary to the first magnetic feature, second kinematic alignment features that are complementary to the first kinematic alignment features, and a central bore that closely accommodates the ferrule; and wherein, whenever the first and second face plates are interfaced, the first and second magnetic features magnetically engage and hold the first and second face plates together while the first and second kinematic alignment features operably align and make contact, thereby placing the fiber end face in axial alignment with and in proximity to the narrow aperture.

Another aspect of the disclosure is a ferrule holder for holding a ferrule of an optical fiber connector and for use with an optical fiber processing tool that includes a light source that emits light. The ferrule holder includes: a first face plate having a first front side, a first central axis and a conical bore along the first central axis, the conical bore having a narrow end that defines a first aperture at the first front side, with the first face plate being operably arranged relative to the optical fiber processing tool, the first face plate further including at least one magnetic feature and one or more first kinematic alignment features operably arranged on the first front side and symmetrically arranged about the first central axis; a second face plate having a second front side, a second back side and a second central axis and and having a cylindrical bore being aligned along the second central axis and sized to receive and closely accommodate the ferrule, the second face plate further including at least one second magnetic feature and one or more second kinematic alignment features operably arranged on the second back side and symmetrically arranged about the second central axis; and wherein the first and second face plates are configured to be removably interfaced with the first front side and the second back side confronting and with the first and second central axes being substantially coaxial so that the first and second magnetic features magnetically engage and hold the first the first and second face plates together while the respective first and second kinematic alignment features operably align and make contact.

Another aspect of the disclosure is a tool assembly for processing an end face of an optical fiber held by a ferrule in an optical fiber connector. The tool assembly includes: an optical fiber processing tool having a light source, an optical system and a front end, wherein the light source generates light and the optical system directs the light to the front end; a ferrule holder operably arranged at the front end of the optical fiber processing tool, the ferrule holder having: a) a first face plate attached to or formed integrally with the front end of the laser tool and having a first magnetic feature, first kinematic alignment features and a conical bore with a wide proximal end and a narrow distal end that defines a narrow aperture and b) a second face plate having a second magnetic feature, second kinematic alignment features that are complementary to the first kinematic alignment features, and a central cylindrical bore, and also having a connector guide that receives a front end of the optical fiber connector so that the ferrule closely resides within the central cylindrical bore; and wherein, whenever the first and second face plates are interfaced, the first and second magnetic features magnetically engage and hold the first and second face plates together while the first and second kinematic alignment features operably align and make contact, thereby placing the fiber end face in axial alignment with and in proximity to the narrow aperture so that the focused light passes through the narrow aperture and to the fiber end face to process the fiber end face.

Another aspect of the disclosure is a method of processing an end face of an optical fiber held in a ferrule of an optical fiber connector. The method includes: generating light from a light source; directing the light through a conical bore of a first face plate in the direction from a wide end of the conical bore to a narrow end that defines a narrow aperture; closely holding the ferrule in a central bore of a second face plate that is magnetically attached to and kinematically aligned with the first face plate so that the narrow aperture is axially aligned with and immediately adjacent the fiber endface; and wherein the light passes through the narrow aperture and is incident upon the end face of the optical fiber with sufficient intensity to substantially polish the end face.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying Figures, in which:

FIG. 1 is a cross-sectional view in the y-z plane of an example optical fiber connector;

FIG. 2A is a cross-sectional view in the y-z plane of an example ferrule;

FIG. 2B similar to FIG. 2A and shows the ferrule of FIG. 2A holding an optical fiber;

FIG. 2C is a close-up view of the front end of the ferrule and optical fiber of FIG. 2B, showing an example wherein some of the bare (stripped) end portion of the optical fiber extends beyond front-end surface of ferrule front end by a protrusion distance DP;

FIG. 2D is similar to FIG. 2C, and shows a focus spot formed at the end face of the bare end portion of the optical fiber that protrudes from the ferrule front-end surface;

FIG. 3 is a side view of an optical fiber processing tool that includes the ferrule holder as disclosed herein and showing an optical fiber connector that includes the ferrule, which is operably engaged by the ferrule holder;

FIG. 4A is a cross-sectional view of an example of the ferrule holder of FIG. 3, shown along with the front-end portion of the optical fiber connector engaged by the ferrule holder;

FIG. 4B is a close-up view of the central portion of the first face plate of the ferrule holder, shown along with ferrule and bare fiber end held therein, and illustrating the alignment and proximity of the end face of the bare end portion of the fiber with the narrow-end aperture of the conical bore;

FIG. 4C is a side-elevated cut-away view of an example ferrule holder of FIG. 4A, wherein the magnetic feature of the first face plate is in the form of magnetic elements and the magnetic feature of the second face plate is the body of the second face plate being made of a ferromagnetic material;

FIG. 4D is similar to FIG. 4C and shows an example ferrule having a first diameter disposed within the central bore of the second face plate.

FIG. 4E is similar to FIG. 4D and shows an example ferrule having a second diameter larger than the first diameter of FIG. 4D, and wherein the ferrule is disposed within a larger central bore of a different second face plate;

FIG. 5A is an elevated view of an example first face plate that includes three kinematic mounting features in the form of spheres, and wherein the magnetic feature is in the form of two magnetic elements on either side of the narrow-end aperture of the conical bore;

FIG. 5B is an elevated view of an example second face plate for use with the first face plate of FIG. 5A, wherein the second face plate includes three kinematic alignment features that are complementary to those of the first face plate, and wherein the magnetic feature is in the form of two magnetic elements that are complementary to those of the first face plate so that the respective magnetic elements of the first and second face plates attract each other; and

FIG. 5C is an isometric back-side view of an example second face plate that includes three spherical or ball-type kinematic mounting features symmetrically arranged around the central bore on the back side of the second face plate, and also showing a portion of a connector guide on the side opposite the kinematic mounting features.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure.

The claims as set forth below are incorporated into and constitute part of this Detailed Description.

Cartesian coordinates are shown in some of the Figures for the sake of reference and are not intended to be limiting as to direction or orientation.

In the discussion below, the term “magnetic” when describing a “magnetic feature” or a “magnetic element” can mean that the feature or element is made of either a magnetized material or a magnetizable material, such as a ferromagnetic material.

### Ferrule and Optical Fiber

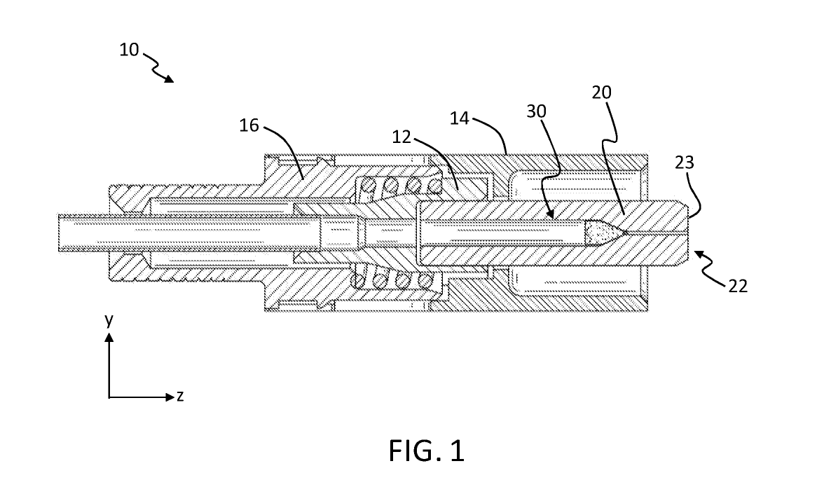

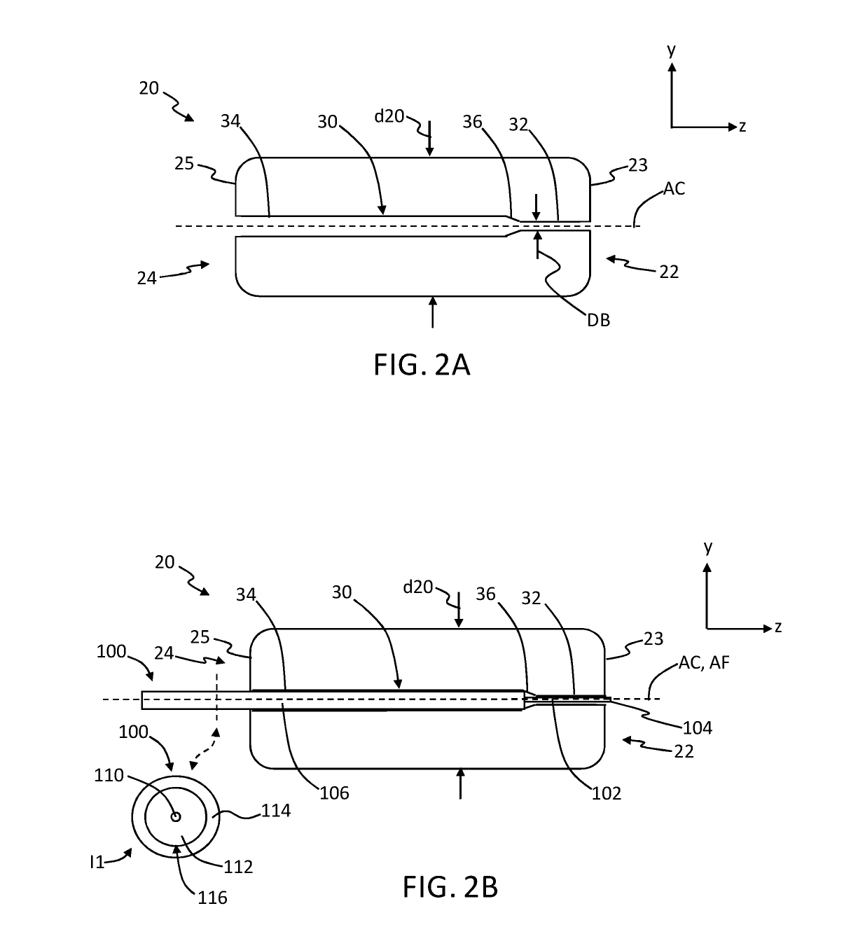

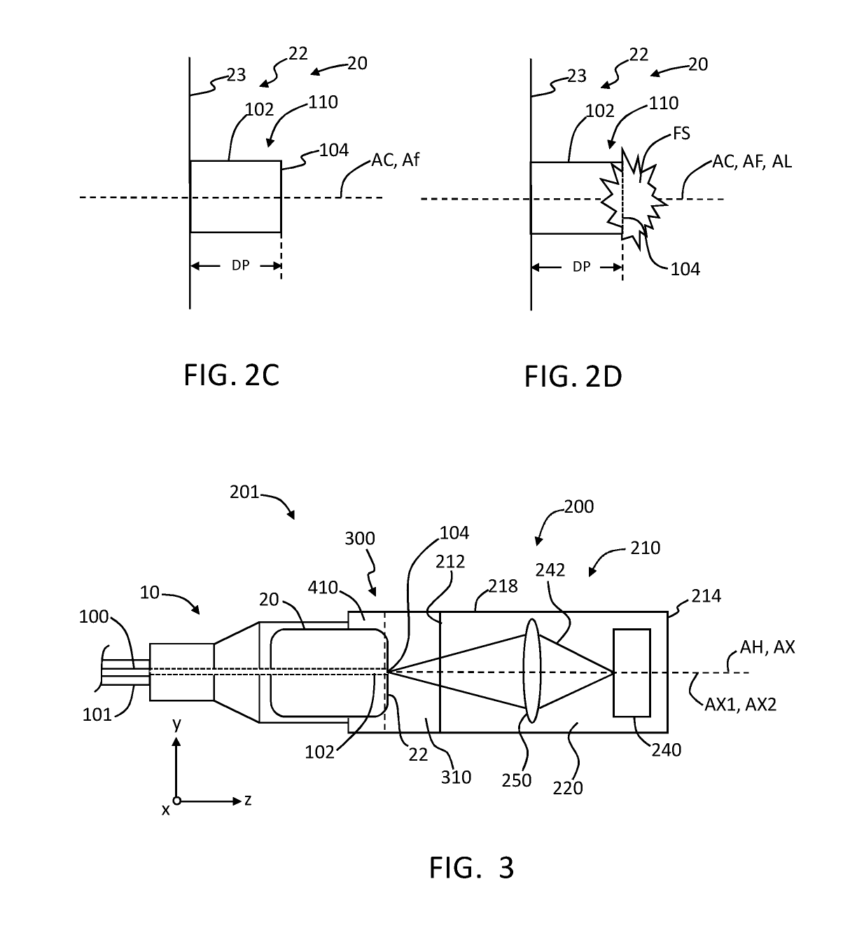

FIG. 1 is a cross-sectional view in the y-z plane of an example optical fiber connector 10 (also referred to as “fiber optic connector 10”, or simply “connector 10”), which includes a ferrule 20 configured to support an optical fiber 100 (see FIG. 2B), a ferrule support member 12 from which ferrule 20 extends, a housing 14 having a cavity in which the ferrule support member is received, and a connector body 16 (also referred to as “inner housing 16”, “retention body 16”, or “crimp body 16”) configured to retain the ferrule support member within housing 14. Connector 10 is merely an example to facilitate discussion. Thus, although connector 10 is shown in the form of a SC-type connector, the disclosure below may be applicable to processes and apparatuses involving different fiber optic connector and ferrule designs. This includes ST, LC, FC, MU, and MPO-type connectors, for example, and other single-fiber or multi-fiber connector or ferrule designs.

With this in mind, FIG. 2A schematically illustrates an example ferrule 20 in isolation, while FIG. 2B is similar to FIG. 2A and shows ferrule 20 holding optical fiber 100, which has a central axis AF. The ferrule 20 includes a front end 22 with a front-end surface 23, a back end 24 with a back-end surface 25, and a central bore 30 that runs along ferrule central axis AC between the front and back ends. The central bore 30 includes a front-end section 32 of diameter DB sized to accommodate a bare end portion 102 of optical fiber 100, wherein the bare end portion terminates at an end face 104. The central bore 30 also includes a back-end section 34 sized to accommodate a coated portion 106 of optical fiber 100. The front-end and back-end sections 32 and 34 of bore 30 transition at an interior wall 36, which in example can be angled toward front end 22 as shown to help guide bare end portion 102 into front-end section 32 of bore 30. In an example, ferrule 20 is made of a ceramic material such as Zirconia. The ferrule 20 has a diameter d20, which as noted above can be 1.25 mm for LC type connectors or 2.5 mm for SC type connectors. Thus, ferrule 20 can have different ferrule diameters d20, depending in the type of connector 10.

The close-up inset 11 of FIG. 2B shows an example cross-sectional view of optical fiber 100. Optical fiber 100 includes a core 110, a cladding 112 that surrounds the core, and a coating 114 that surrounds the cladding. The core 110 and cladding 112 define an optical waveguide 116, while coating 114 serves a protective (i.e., non-waveguide) function. The bare end portion 102 is formed by stripping away a select amount of coating 114, leaving just cladding 110 and core 112. In an example, coating 114 is made of acrylate, a polymer, or like material. The core 110 and cladding 112 are typically made of glass, e.g., silica, and one or both can include dopants that define a refractive index profile for optical fiber 100. Thus, in an example, optical waveguide 116 is a glass waveguide. Single mode optical fibers 100 can have a core diameter of about 9 microns while nnultinnode optical fibers can have a core diameter of about 50 microns or about 62.5 micron, while a typical optical fiber diameter (i.e., cladding outer diameter) is about 125 microns.

FIG. 2C is a close-up view of ferrule front end 22 that shows an example wherein some of bare end portion 102 of optical fiber 100 extends beyond front-end surface 23 of the ferrule front end by a protrusion distance DP. In an example, DP≦250 nm. This configuration of optical fiber 100 in ferrule 20 is typically accomplished by a conditioning step that involves coarse polishing of fiber end face 104 of bare end portion 102. Such coarse polishing invariably creates scratch marks and other defects in end face 104.

Consequently, after the coarse polishing step, end face 104 needs to be further polished to eliminate or minimize the scratch marks and other defects. However, this needs to be accomplished without substantially changing the protrusion distance DP. This is accomplished in one example using an optical fiber processing tool 200 (introduced and discussed below; see FIG. 3) configured to perform non-contact processing of fiber end face 104 to form a highly polished end face in a single polishing step.

FIG. 2D is similar to FIG. 2C, and shows a focus spot FS formed by the optical fiber processing tool. The focus spot FS is formed substantially at (e.g., to within +/−100 microns of) end face 104 of the bare end portion 102 in carrying out the non-contact polishing method, as described in greater detail below. Without such scratch/defect removal, connector optical performance specifications, such as insertion loss (IL) and back reflection (BR), cannot be met. Also, with the defect and flaws introduced during the aforementioned mechanical conditioning step, end face 104 of optical fiber 100 may be prone to chipping with repeated connector matings and dennatings.

Optical Fiber Processing Tool with Ferrule Holder

FIG. 3 is a cross-sectional view of an example optical fiber processing tool (“tool”) 200 shown along with a ferrule holder 300 according to the disclosure. Ferrule holder 300 includes first and second face plates 310 and 410. Details of ferrule holder 300 are discussed in greater detail below. An example tool 200 is disclosed in U.S. Provisional Patent Application No. 62/165,322, filed on May 22, 2015, and in European Patent Application Serial No. 15168893.4, filed on May 22, 2015, both applications being incorporated herein by reference. The combination of tool 200 and ferrule holder 300 constitutes a tool assembly 201. As noted above, tool 200 is configured to perform non-contact processing of fiber end face 104 using light, such as laser light. The connector 10 engages ferrule holder 300 on the side opposite tool 200 as described below.

An example tool 200 includes a housing 210 having a central axis AH, a front end 212, a back end 214, an outside surface 218 and an interior 220. In an example, ferrule holder 300 is located at the front end 212 of housing 210. In an example, housing 210 is sized so that tool 200 can be hand-held by a user, such as a field technician.

The tool 200 includes a light source system 240 arranged in interior 220 along housing central axis AH and adjacent or towards housing back end 214. Light source system 240 generates light 242 having an operating wavelength suitable for processing (e.g., polishing by heating or melting) end face 104 of optical fiber 100. The light source system 240 can include a laser, such as a quantum cascade laser, vertical-cavity surface-emitting laser or VCSEL, a diode laser (i.e., a semiconductor laser), etc.

An optical system 250 that can include one or more optical elements (e.g., lens elements, mirrors, gratings, filters, beam splitters, etc.) is operably arranged between light source system 240 and housing front end 212. The optical system 250 is configured (and in an example is adjustable) to direct light 242 from the light source system to end face 104 of fiber 100. In an example, light 242 is made convergent or is otherwise focused by optical system 250 to form focus spot FS (see FIG. 2D). In the discussion below, light 242 is also referred to as light beam 242. The optical system 250 is represented schematically in FIG. 3 as a single lens element for ease of illustration.

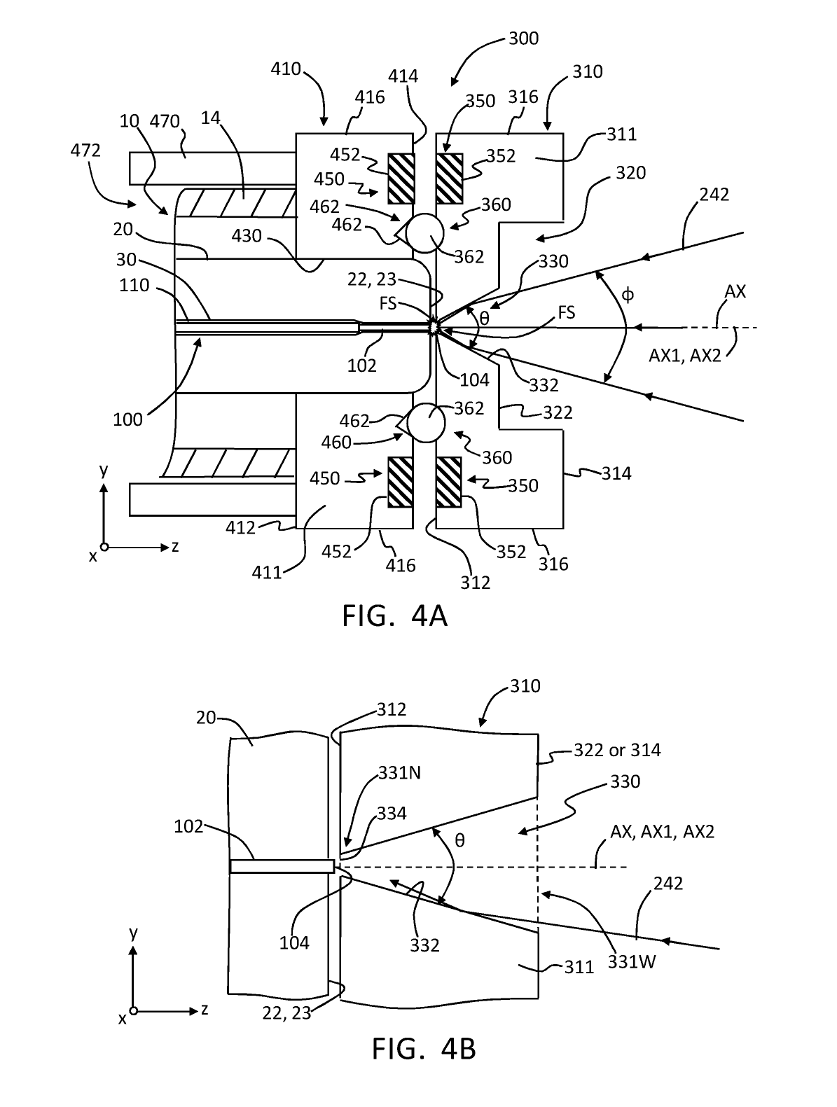

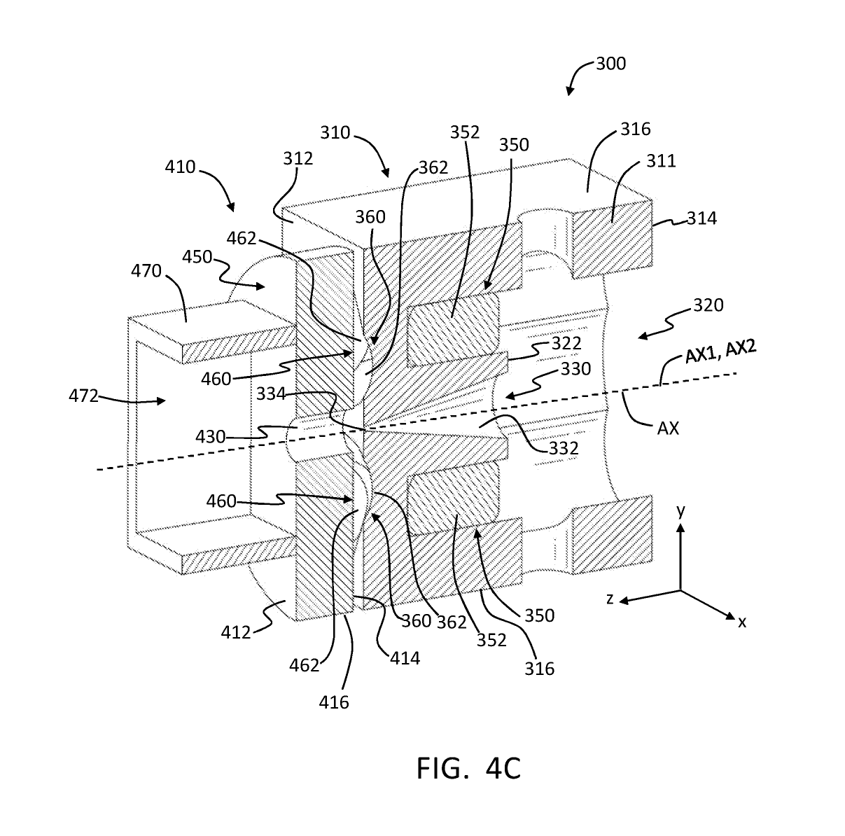

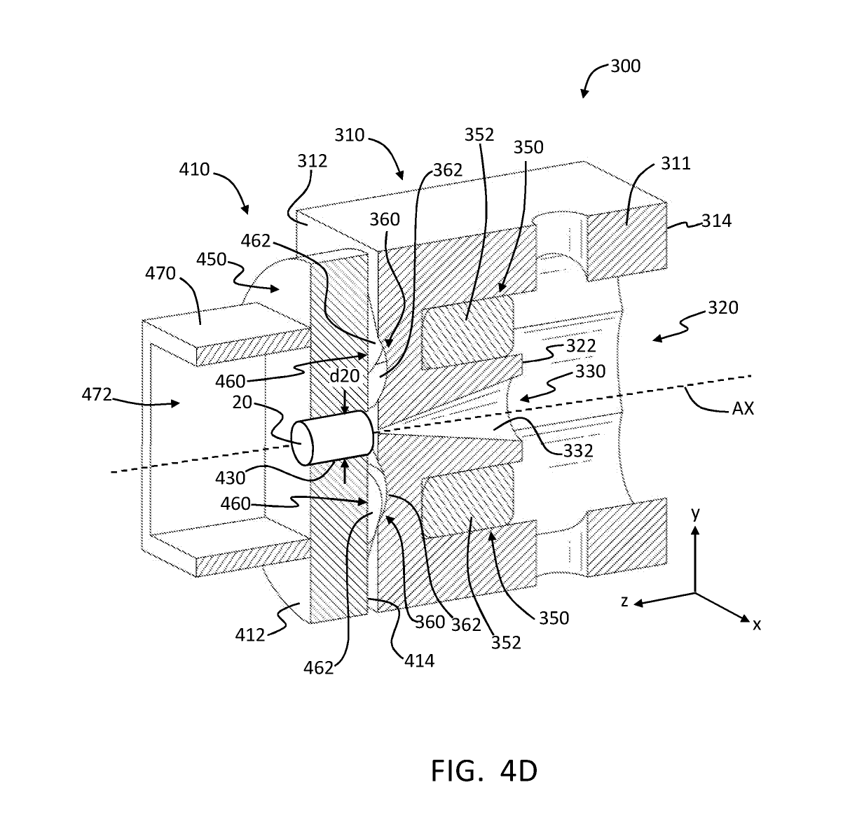

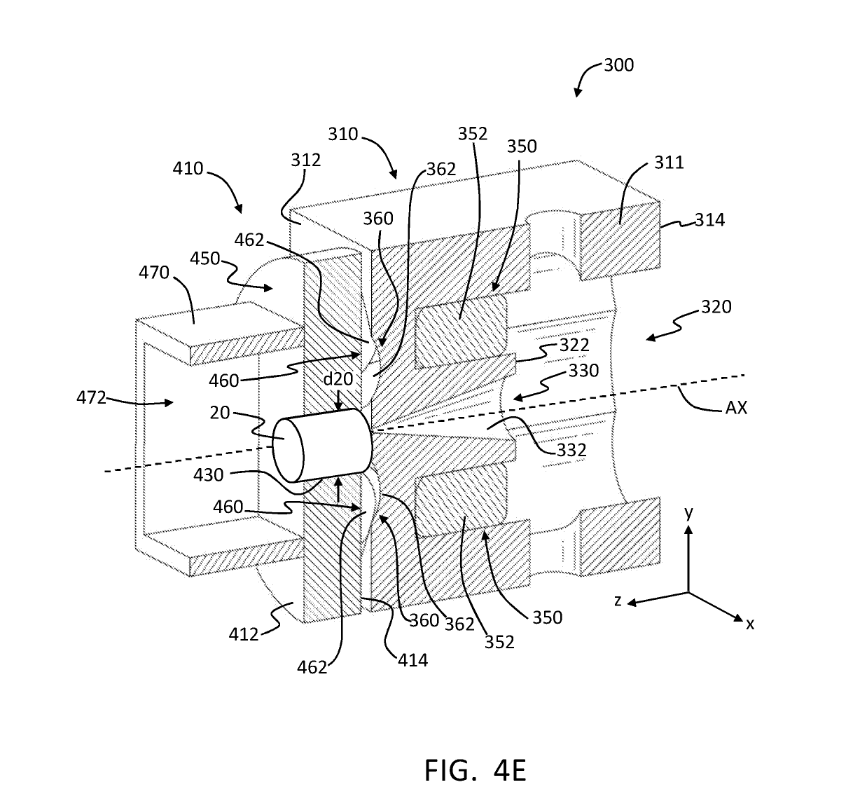

FIG. 4A is a close-up cross-sectional view of an example of ferrule holder 300 and shows the front-end portion of optical fiber connector 10 (see FIG. 1) operably engaged therewith. The ferrule holder 300 has a central axis AX and includes first face plate 310 that can be mounted or attached to or integrally formed on front end 212 of housing 210 of tool 200. The ferrule holder 300 also includes second face plate 410 that operably and removably interfaces or mounts or attaches to the first face plate as described below. The first and second face plates 310 and 410 can each have a rectangular cross-sectional shape, which may be convenient with respect to matching a rectangular cross-sectional shape of housing 210 of tool 200. Other cross-sectional shapes for the first and second face plates 310 and 410 can be effectively employed as well. Because the first face plate 310 is attached to or is integrally formed with tool 200, it can be referred to as the “tool face plate.” Also, because the second face plate is used to receive connector 10, it can be referred to as the “connector face plate.”

FIG. 4B is a close-up view of the central portion of first face plate 310 along with ferrule 20 and bare fiber end 102 held therein. FIG. 4C is a side-elevated cut-away view of another example of ferrule holder of FIG. 4A showing different example configurations of the first and second face plates 310 and 410.

With reference to FIGS. 4A through 4C, first face plate 310 includes a central axis AX1, a body 311 and generally planar front side 312, an opposite and generally planar back side 314, and top and bottom sides 316. The back side 314 includes an optional central recess 320 that has an inner wall 322 that is generally parallel to front side 312 and back side 314. The inner wall 322 (or alternatively, back side 314) includes a central conical bore 330 centered on central axis AX1 and having a wide proximal end 331W end at inner wall 322 (or back side 314) and a narrow distal end 331N at front side 312 (see FIG. 4B). The conical bore 330 has an inner surface 332. In an example, conical bore 330 has an cone angle θ that is about the same as or greater than an angle φ associated with the converging light 242 from optical system 250, as shown in FIG. 4A. In an example shown in FIG. 4B, conical bore 330 extends from back side 314 to front side 312, i.e., there is no optional central recess 320.

As best seen in FIGS. 4B and 4C and as noted above, the narrow distal end 331N of conical bore 330 terminates at front side 312 and forms a narrow-end aperture (“aperture”) 334. Generally speaking, aperture 334 can have any diameter suitable for processing fiber end face 104. In an example, aperture 334 has a diameter that is about the same as that of fiber end face 104. In other examples, aperture 334 is slightly smaller than or slightly larger than the diameter of fiber end face 104. Thus, in an example, aperture 334 can have a diameter that is within about 25% of the diameter of fiber end face 104. In other examples, aperture 334 has a diameter in the range from 50 to 150 microns, or from 60 microns to 100 microns.

In an example, inner surface 332 of conical bore 330 is smooth, and further in the example is highly reflective (e.g., greater than 90% reflective, or greater than 95% reflective). In an example, inner surface includes a reflectivity coating (not shown) to provide optimum reflection for the operating wavelength or wavelengths of light 242 from light source system 240.

### The First Face Plate

In an example, first face plate 310 includes at least one first magnetic feature 350. In an example, the at least one first magnetic feature 350 is constituted by one or more magnetic elements 352 operably disposed at or near front side 312 and symmetrically arranged about central axis AX1. In one example, two first magnetic elements 352 are employed, while in other examples three or four first magnetic elements are employed. In another example, the at least one first magnetic feature 350 is constituted by at least a portion of body 311 being magnetic or being made of a magnetizable (e.g., ferromagnetic) material.

The first face plate 310 further includes a plurality of first kinematic alignment features 360 disposed on or in front side 312, or formed in front side 312. In an example, the first kinematic features 360 are symmetrically arranged about central axis AX1. In an example, the first kinematic alignment features 360 include first alignment elements 362 such as spheres or balls or portions of a sphere, or bumps or protrusions that extend from front side 312. In an example, three first kinematic alignment features 360 are employed. FIG. 4A illustrates an example where the first kinematic alignment features include first alignment elements 362 in the form of spheres.

Also in an example, first face plate 310 can be formed as a part of (e.g., integrally with) tool 200 or can be configured as a separate piece to be added on to the front end 212 of the tool. In an example, first face plate 310 is precision mounted to or fixed or integrally fabricated with the front end 212 of housing 210 of tool 200 so that conical bore 330 and aperture 334 are precisely aligned along central axis AX and with optical system 250 and light source system 240. This allows for good alignment of the light source 240, optical system 250 and aperture 334 to be maintained when tool 200 is deployed in the field.

### The Second Face Plate

The second face plate 410 includes a central axis AX2, a body 411 and a generally planar front side 412, an opposite and generally planar back side 414, and top and bottom sides 416. Note that in the embodiment of FIG. 4C, second face plate 410 has a circular shape so that “sides” 416 becomes perimeter 416. The second face plate 410 include a central bore 430 having a cylindrical shape and that runs between the front and back sides 412 and 414 along central axis AX2 and is sized to closely accommodate ferrule 20. In an example, central bore 430 is precision machined (e.g., to micron or sub-micron levels) to closely match the size (e.g., diameter d20) of a particular ferrule 20 used in connector 10.

The second face plate 410 also includes at least one second magnetic feature 450, such as at least a portion of body 411 being magnetic or magnetizable (see, e.g., FIG. 4C), or such as one or more second magnetic elements 452 operably disposed at or in front side 412 and symmetrically arranged about central axis AX2 (see, e.g., FIG. 4A). In the example shown in FIG. 4A, the one or more second magnetic elements 452 are axially aligned with the one or more magnetic elements 352 of first face plate 310 when the second face plate 410 is operably aligned and engaged with first face plate 310. In an example, the same number of second magnetic elements 452 is employed as the number of first magnetic elements 352. The one or more second magnetic elements 452 have the opposite polarity as compared to the one or more first magnetic elements 352 so that the first and second magnetic elements attract each other and magnetically engage when brought into proximity with one another.

In another example such as shown in FIG. 4C, the at least one second magnetic feature 450 of second face plate 410 is defined by at least a portion of the second face plate being made of a magnetic or ferromagnetic material or wherein the body 411 otherwise includes a magnetic or ferromagnetic material so that the second face plate is attracted to and magnetically engages magnetic elements 352 in first face plate 310.

Also in an example, one of the first and second magnetic elements 352 and 452 can be magnetic while the other can be a ferromagnetic material, i.e., the first and second magnetic elements 352 and 452 do not need to both be magnetic. This is because a ferromagnetic material becomes temporarily magnetized when subjected to the magnetic field. Some ferromagnetic materials (e.g., iron) can become permanently magnetized when subjected to a magnetic field. Also in an example, some of the magnetic elements 352 and/or 452 can be magnets while others can be magnetizable (e.g., made of a magnetizable material). In an example, a single magnetic element in the form of a ring or annulus can be employed. In an example, magnetic features 350 and 450 can each include alignment features (not shown) that facilitates alignment of the first and second face plates 310 and 410 when they are operably interfaced.

In another example, both first and second face plates 310 and 410 can be magnetic, or one face plate can be magnetic while the other face plate can be made of a ferromagnetic or otherwise magnetizable material. An advantage of using discrete magnetic elements 352 and/or 452 is that the remainder of the face plate body 311 or 411 can be made of a lightweight material, such as plastic, molded polymer, aluminum, etc.

The second face plate 410 further includes a plurality of second kinematic alignment features 460 disposed on or in front surface 412. The second kinematic alignment features 460 are complementary to the first kinematic alignment features 360 so that they can operably engage or otherwise operably make mechanical contact. The second kinematic alignment features 460 are arranged so that they axially align with and make mechanical contact the first kinematic alignment features 360 when the the second face plate is operably aligned with and engaged with first face plate 310, with central axes AX1 and AX2 of the respective first and second face plates being substantially co-axial with each other and with the central axis AX of ferrule holder 300.

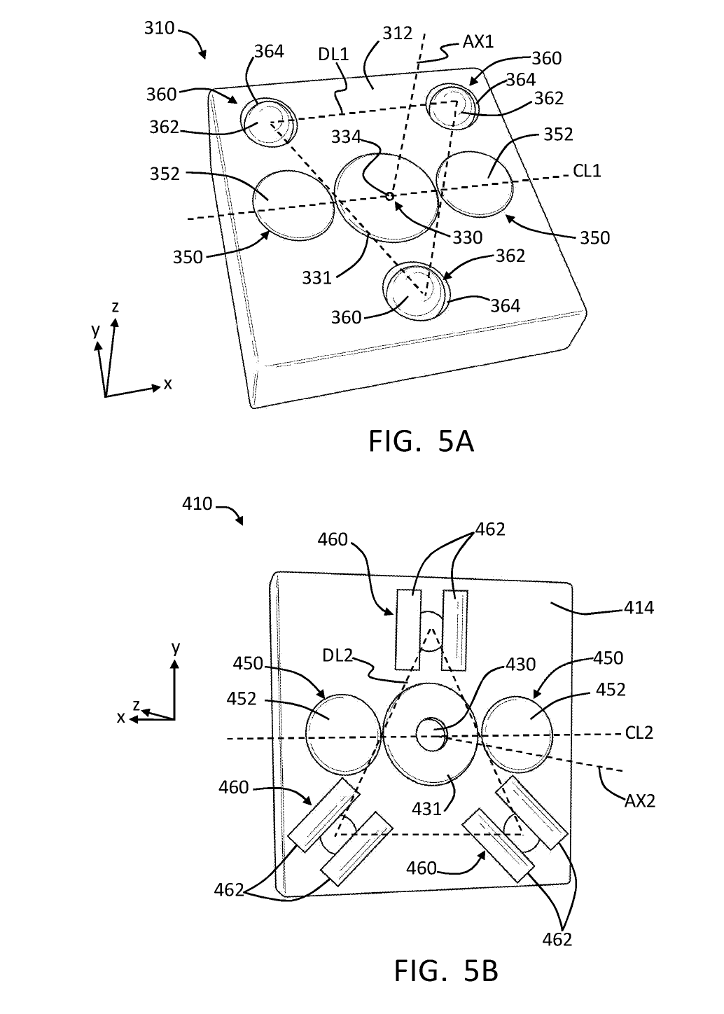

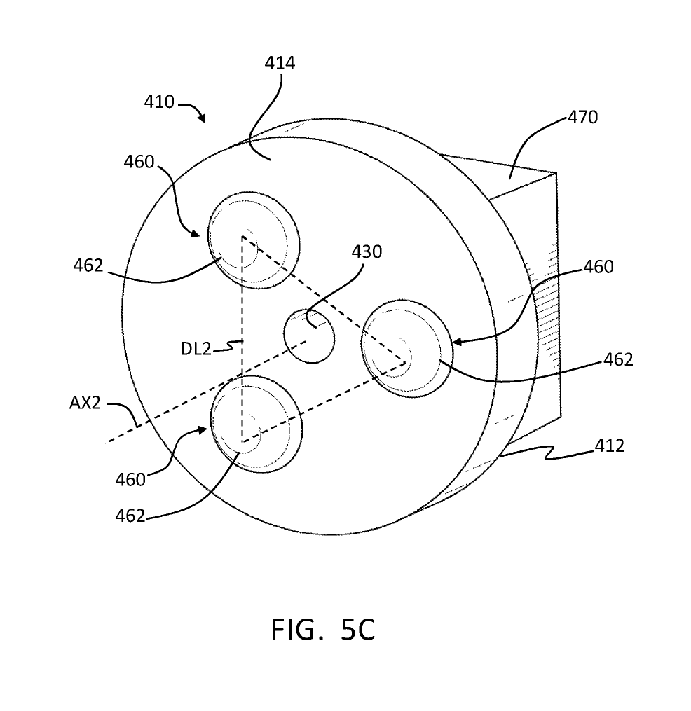

In an example, second kinematic alignment features 460 comprise second alignment features 462, such as grooves formed in front surface 412 as shown in FIG. 4A. In another example, second alignment features 462 include linear and parallel protrusions or bars that define a groove (see, e.g., FIG. 5B, introduced and discussed below). In an example, the number of second kinematic alignment features 460 is the same as the number of first kinematic alignment features 360. In the example shown in FIG. 4A, the first kinematic alignment features 360 are male while the second kinematic alignment features 460 are female. In another example such as shown in FIG. 4C, the first kinematic alignment features 360 are female while the second kinematic alignment features 460 are male.

In an example, second face plate 410 includes a connector guide 470 at front side 412. The connector guide 470 defines an opening 472 sized to receive and closely accommodate and otherwise support at least the front-end portion of connector housing 14 of connector 10 so that ferrule 20 of the connector aligns with and closely resides within central bore 430 so that fiber end face 102 is in a position to be processed by light 242 from tool 200.

The respective bodies 311 and 411 of first and second face plates 310 and 410 can be made of molded polymer and can include metal portions added thereto, including magnetic elements 352 and/or 452, or other magnetic features 350 and 450, as well as modular parts that define the conic bore 330 and the central bore 430. The respective bodies 311 and 411 can also be formed to include first and second kinematic alignment elements 362 and 462.

In practice, multiple second face plates 410 are fabricated, each with a different sized central bores 430 so that the appropriate second face plate can be used with tool 200, depending on the size (e.g., diameter d20) of ferrule 20 used in optical fiber connector 10. FIG. 4D is similar to FIG. 4C and shows an example ferrule 20 having a first diameter d20 disposed within the central bore 430 of second face plate 410. FIG. 4E is similar to FIG. 4D and shows an example wherein ferrule 20 has a second diameter d20 larger than the first diameter of FIG. 4D, and the central bore 430 is larger to accommodate the larger diameter ferrule.

### Configuration of Face Plates for Processing the Fiber End Face

As noted above, tool 200 is used to process the fiber end face 104 as part of a tool assembly 201. When performing processing of fiber end face 104 using tool 200, first and second face plates 310 and 410 are arranged (i.e., interfaced) with the front side 312 of the first face plate confronting the back side 414 of the second face plate. The central axes AX1 and AX2 are substantially coaxial with each other and with the central axis AX of the fiber holder 300 so that the respective first and second magnetic features 350 and 450 are operably aligned and magnetically engage, and the respective first and second kinematic alignment features 360 and 460 are aligned and come into mechanical contact. The ferrule 20 of connector 10 resides within the central bore 430, with the ferrule front-end surface 23 protruding slightly from the back side 414 of the second face plate 410.

Because central bore 430 and conical bore 330 are each centered on central axis AX, and because central axes AX1 and AX2 are substantially coaxial, the fiber end face 104 is axially aligned with aperture 334 of the conical bore and resides in close proximity thereto. The conical bore 330 and its reflective inner surface 332 can serve as a guiding taper that directs light 242 to aperture 334. Thus, even if there is a small directional error for light 242 coming from optical system 250, the light will be funneled to aperture 334 via reflection from inner surface 332 of conical bore 330. In an example, most if not all of the reflections from reflective inner surface are at a grazing incidence, which is known in the art to have a high reflectance, especially from a smooth surface.

The use of first and second magnetic features 350 and 450 to magnetically engage and keep the the first and second face plates 310 and 410 pressed together allows the second face plate to be easily removed from the first face plate. This in turn allows for a different second face plate 410 having a different sized central bore 330 to be exchanged for the original second face plate of ferrule holder 300. Meanwhile, the first and second kinematic alignment features 360 and 460 provide for precise mechanical alignment of fiber end face 104 with aperture 334 when the first and second faceplates 310 and 410 are magnetically engaged and the kinematic alignment features come into contact. This ensures that fiber end face 104 substantially coincides with focus spot FS formed by tool 200.

In an example, the alignment between the first and second faceplates 310 and 410 is in the range from 5 microns to 20 microns for a lateral offset and in the range from about 50 microns to 150 microns for a longitudinal offsets. In another example, the alignment is 10 microns or better for a lateral offset and 100 microns or better for a longitudinal offset.

Because light 242 is directed toward (e.g., focused substantially at) aperture 334, the focus spot FS will substantially coincide with the fiber end face 104, which is located immediately adjacent aperture 334 of conical bore 330. Furthermore, as noted above, some of light 242 can reflect from the reflective inner surface 332 of conical bore 330 and be directed through aperture 334, thereby making efficient use of the light and further contributing the intensity of focal spot FS.

### Additional Face Plate Examples

FIG. 5A is an elevated view of the front side 312 of an example first face plate 310. The example first face plate 310 includes three first kinematic alignment features 360 having first alignment elements 362 in the form of spheres arranged in a triangular geometry (as shown by dashed line DL1) on the front side 312. In an example, the spheres 362 reside in indentations 364 formed in front side 312. The spheres 362 may be secured (e.g., by adhesive) or otherwise retained in indentations 364, or the spheres 362 may be loosely received in the indentations. In the latter situation, spheres 362 are still considered as part of the first face place 310 for the purposes of this disclosure.

The aperture 334 associated with conic bore 330 (see, e.g., FIG. 4B) is shown as part of a first cylindrical modular member 331 supported by body 311 of the first face plate 310. The example first face plate 310 also includes two first magnetic elements 352 arranged along a center line CL1 that runs in the x-direction. Note that in this embodiment, the body 311 of first face plate 310 can be made of a lightweight material such as plastic, molded polymer, aluminum, etc., while the first cylindrical modular member 331 and the two first magnetic elements 352 can be made of a different material (e.g., metal) and added to the body.

FIG. 5B is an elevated view of the back side 412 of an example second face plate 410 configured to operably interface and engage with the first face plate 310 of FIG. 5A. The second face plate 410 includes three second kinematic alignment features 460 also arranged in a triangular geometry, as shown by dashed line DL2. The three kinematic alignment features 60 each include second alignment elements in the form of parallel spaced-apart bars 462 configured to receive one of the spheres 362. The second face plate 410 has its central bore 430 defined by a second cylindrical modular member 431 supported by the body 411 of the second face plate 410. The example second face plate 410 also includes two magnetic elements 452 arranged along a center line CL2 that runs in the x-direction. As with the first face plate 310 of FIG. 5A, body 411 of second face plate 410 of FIG. 5B can be made of a lightweight material while the second cylindrical modular member 431 and the two magnetic elements 462 can be added to the body.

Whenever the first and second face plates 310 and 410 of FIGS. 5A and 5B respectively are interfaced, the spheres 362 of the first kinematic alignment features 360 mechanically engage with the parallel bars 462 of the second kinematic alignment features and place to the two face plates in axial alignment. Meanwhile, the first magnetic elements 352 magnetically engage the second magnetic elements 452 by providing an attractive magnetic force that urges (pulls) the first and second face plates 310 and 410 toward one another together and keeps them in mechanical contact via the first and second kinematic alignment features 360 and 460. The attractive magnetic force is strong enough to keep the first and second face plates 310 and 410 pressed together and in aligned mechanical contact for laser processing the fiber end face 104 using tool 200. On the other hand, the attractive magnetic force is weak enough to allow for a user to manually separate the first and second face plates 310 and 410. This allows for different second face plates 410 to be used for connectors 10 having different sized ferrules 20.

FIG. 5C is isometric back-side view of another example embodiment of second face plate 410. The second face plate 410 includes symmetrically arranged kinematic alignment features 460 on back side 414. The kinematic alignment features 460 are defined by three spheres 462 arranged in a triangular geometry (dotted line DL2) about central bore 430. A portion of connector guide 470 is shown on the front side 412 of the second face plate 410. The connector guide 470 is shown by way of example to have a rectangular shape to accommodate a rectangular housing 14 of connector 10. Other shapes for connector guide 470 can be employed that correspond to the particular shape of housing 14 of connector 10.

### Ferrule Holder Advantages

The ferrule holder 300 disclosed herein has a number of advantages. One advantage is that it is configured to accommodate different size ferrules 20 used in different connectors 10 by being able to exchange one second face plate 410 for another having a different central bore diameter. Another advantage is that the ferrule holder 300 is configured so that the second face plate 410 can be removed manually and quickly from the first face plate 310 because a magnetic force is used to attach the two face plates. This is important because in an example, the entire connectorization process (including fiber end face processing) is preferably carried out in the field within about two minutes or so per connector. Another advantage is that the first and second kinematic alignment features 360 and 460 provide for the precise lateral and longitudinal alignment required when the first and second face plates 310 and 410 are interfaced so that the processing of fiber end face 104 is efficient and does not need to be repeated.

Another advantage is that the first and second face plates 310 and 410 can be formed using a molding process that offers low cost as well as precision construction. The molding process also allows for modular parts to be added to each of the face plates, such as modular metal members that define the central bore 430 that support ferrule 20 or the conical bore 330 that guides light toward aperture 334 and to fiber end face 102.

Another advantage is that the conical bore 330 of first face plate 310 can guide or funnel light 242 toward aperture 334 even if there is an offset in light beam 242 relative to the tool central axis AX. The tool 200 typically has a limited pointing angle accuracy, e.g., of about 1 degree or so, which leads to a corresponding lateral misalignment of the focused light 242 with respect to aperture 334 of conical bore 330. Here, conical bore 330 can serve to guide any misdirected light 242 through aperture 334 by grazing-incidence reflection from the inner wall 332. Because grazing-incidence reflection has a high reflectivity, the optical loss due to reflection is negligible. Further, because the fiber end face 104 is located immediately adjacent aperture 334, the intensity of focus spot FS at the fiber end face will not be substantially reduced by the small angular misalignments of light beam 242.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A ferrule holder for holding a ferrule of an optical fiber connector, wherein the ferrule holds an optical fiber having an end face to be processed by an optical fiber processing tool that uses light, the ferrule holder comprising:
a first face plate having a first magnetic feature, first kinematic alignment features and a conical bore with a wide proximal end and a narrow distal end that defines a narrow aperture;
a second face plate having a second magnetic feature complementary to the first magnetic feature, second kinematic alignment features that are complementary to the first kinematic alignment features, and a central bore that closely accommodates the ferrule; and
Wherein, whenever the first and second face plates are interfaced, the first and second magnetic features magnetically engage and hold the first and second face plates together while the first and second kinematic alignment features operably align and make contact, thereby placing the fiber end face in axial alignment with and in proximity to the narrow aperture.

2. The ferrule holder according to claim 1, wherein the either the first or second magnetic feature includes the first or second face plate being at least partially made of a ferromagnetic material.

3. The ferrule holder according to claim 1, wherein the one of the first and second kinematic alignment features includes a plurality of spheres.

4. The ferrule holder according to claim 1, wherein at least one of the first and second magnetic features includes a plurality of magnetic elements.

5. The ferrule holder according to claim 1, wherein the light passes through the narrow aperture and forms a focus spot substantially at the fiber end face.

6. A ferrule holder for holding a ferrule of an optical fiber connector and for use with an optical fiber processing tool that includes a light source that emits light, comprising:
a first face plate having a first front side, a first central axis and a conical bore along the first central axis, the conical bore having a narrow end that defines a first aperture at the first front side, with the first face plate being operably arranged relative to the optical fiber processing tool, the first face plate further including at least one magnetic feature and one or more first kinematic alignment features operably arranged on the first front side and symmetrically arranged about the first central axis;
a second face plate having a second front side, a second back side and a second central axis and and having a cylindrical bore being aligned along the second central axis and sized to receive and closely accommodate the ferrule, the second face plate further including at least one second magnetic feature and one or more second kinematic alignment features operably arranged on the second back side and symmetrically arranged about the second central axis; and
wherein the first and second face plates are configured to be removably interfaced with the first front side and the second back side confronting and with the first and second central axes being substantially coaxial so that the first and second magnetic features magnetically engage and hold the first the first and second face plates together while the respective first and second kinematic alignment features operably align and make contact.

7. The ferrule holder according to claim 6, wherein one of the first kinematic alignment features and the second second kinematic alignment features include three spheres while the other includes three grooves configured to receive the three spheres.

8. The ferrule holder according to claim 6, wherein the second front end includes a connector guide configured to receive and closely accommodate at least a front end of the optical fiber connector so that the ferrule is received in the central bore of the second face plate whenever the optical fiber connector is operably received by the connector guide.

9. The ferrule holder according to claim 6, wherein one or both of the at least one first and at least one second magnetic features includes at least one magnetic element.

10. The ferrule holder according to claim 6, wherein the at least one first magnetic feature includes one or more first magnetic elements and the at least second magnetic feature includes either one or more second magnetic elements or at least a portion of the second face plate being magnetizable.

11. The ferrule holder according to claim 6, wherein the at least one first magnetic feature includes two magnetic elements arranged along a line passing through the first central axis and on opposite sides of the first central axis.

12. A tool assembly, comprising:
the ferrule holder according to claim 6;
the optical fiber processing tool, wherein the optical fiber processing tool has a front end, and wherein the first face plate of the ferrule holder is attached to or is integrally formed with the front end of the optical fiber processing tool.

13. The tool assembly according to claim 12, further including the optical fiber connector operably engaged with the second front side of the second face plate so that the ferrule resides within the central bore of the second face plate.

14. A tool assembly for processing an end face of an optical fiber held by a ferrule in an optical fiber connector, comprising:
an optical fiber processing tool having a light source, an optical system and a front end, wherein the light source generates light and the optical system directs the light to the front end;
a ferrule holder operably arranged at the front end of the optical fiber processing tool, the ferrule holder having: a) a first face plate attached to or formed integrally with the front end of the laser tool and having a first magnetic feature, first kinematic alignment features and a conical bore with a wide proximal end and a narrow distal end that defines a narrow aperture and b) a second face plate having a second magnetic feature, second kinematic alignment features that are complementary to the first kinematic alignment features, and a central cylindrical bore, and also having a connector guide that receives a front end of the optical fiber connector so that the ferrule closely resides within the central cylindrical bore; and
wherein, whenever the first and second face plates are interfaced, the first and second magnetic features magnetically engage and hold the first and second face plates together while the first and second kinematic alignment features operably align and make contact, thereby placing the fiber end face in axial alignment with and in proximity to the narrow aperture so that the focused light passes through the narrow aperture and to the fiber end face to process the fiber end face.

15. The tool assembly according to claim 14, wherein the light source includes a semiconductor laser.

16. The tool assembly according to claim 14, wherein at least a portion of one of the first and second face plates includes a ferromagnetic material.

17. The tool assembly according to claim 14, wherein at least one of the first and second magnetic features includes a plurality of magnetic elements.

18. The tool assembly according to claim 14, wherein at least one of the first and second kinematic alignment features includes a plurality of spheres.

19. A method of processing an end face of an optical fiber held in a ferrule of an optical fiber connector, comprising:
generating light from a light source;
directing the light through a conical bore of a first face plate in the direction from a wide end of the conical bore to a narrow end that defines a narrow aperture;
closely holding the ferrule in a central bore of a second face plate that is magnetically attached to and kinematically aligned with the first face plate so that the narrow aperture is axially aligned with and immediately adjacent the fiber endface; and
wherein the light passes through the narrow aperture and is incident upon the end face of the optical fiber with sufficient intensity to substantially polish the end face.

20. The method according to claim 19, wherein the conical bore includes an inner surface, and including reflecting from the inner surface a portion of the light before the portion of the light passes through the narrow aperture of the conical bore.

21. The method according to claim 19, including disengaging the second face plate from the first face plate and magnetically engaging another second face plate to the first face plate, wherein the another second face plate has a central bore diameter different from the disengaged second face plate.

22. The method according to claim 19, including directing the light using an optical system operably arranged between the light source and the first face plate.

23. The method according to claim 19, wherein the the narrow aperture and the end face of the optical fiber has a lateral misalignment of 10 microns or less.

24. The method according to claim 19, wherein the magnetic attachment of the first and second face plates is performed using first and second magnetic features of the first and second face plates, respectively.

25. The method according to claim 19, wherein the kinematic alignment is perform using first kinematic alignment features on the first face plate and complementary second kinematic alignment features on the second face plate.
